(19) United States
(12) Patent Application Publication
(10) Pub. No.: US 2008/0319848 A1
(43) Pub. Date: Dec. 25, 2008

(54) Fresh ad

(76) Inventors: Jonathan Starr, Edgewater, NJ (US); Adam M. Cohen, Brooklyn, NY (US); Daniel Romero, Brooklyn, NY (US)

Correspondence Address: MICHAEL RIES, 318 PARKER PLACE, OSWEGO, IL, 60543, US

(21) Appl. No.: 11/800,191

(22) Filed: May 4, 2007

Related U.S. Application Data
(60) Provisional application No. 60/798,040, filed on May 5, 2006.

(51) Int. Cl. G06Q 30/00; B65D 85/16

(52) U.S. Cl. 705/14; 206/459.5

(57) ABSTRACT

The present invention is a wipe or towelette with advertising space that may be on an outside package or on the wipe itself. The wipe is attached to a product, the product is of a type that would that may have a user utilize the wipe for cleaning various body parts of the user after touching the product.

This application claims the benefit of U.S. Provisional Patent Application Ser. No. 60/798,040, filed May 5, 2006.

### TECHNICAL FIELD & BACKGROUND

The present invention generally relates to the field of marketing using wipes. More specifically, the present invention relates to combining a wipe or wet nap with a fresh ad or advertising space on the outside wrapper or wipe itself and affixing the wipe to a particular product that may call for a wipe or wet nap to be used after a person touches the particular product.

The present invention is a wet nap or moist towelette with advertising that may be on the outside wrapper. Some wipes do not need packaging so the ad space would be on the wipe itself. The wipe would be affixed to a product, the product would have a need for a user to utilize the wipe to clean body parts of the user or others around the user such as a baby. The product may be of the type that would cause the user to get soiled or unclean after touching the product. The user may want to clean their hands and/or mouth after using the product. The wipe would be affixed to the product with an adhesive. The adhesive may be a clear rubber cement or any other suitable adhesive.

The present invention may be used on a newspaper cover that may have national or local campaigns. The wrapper may have an advertisement that would contain a coupon. Any product that may soil a user's hands would be a candidate for the advertising wipe. Some products and packaging may be pizza boxes, cheese doodles, popcorn bags at movie theaters and many more. This unique advertising space would make an existing product produce more revenue by adding revenue flow by charging third party advertisers for this new advertising space. Also the product would be more desirable to the consumer or user because the wipe would be available to clean up after using or touching the product making a more clean and sanitary environment for the user to reduce possible spread of colds, flu and other diseases.

Typical wipes have advertising for the manufacturer of the wipe or advertising for the restaurant or establishment where a user would find the wipe. The present invention has third party advertising on the new advertising space on the wipe. The wipe may also be in a unique shape connected to the product that the wipe is attached to. A pizza box may have a wipe attached that is in a shape of a slice of pizza. The present invention has third party advertising which means that the product that the wipe is attached may not be advertised in the advertising space nor is a possible establishment that you find the wipe advertised in the new advertising space. The advertising space is used to market a third party advertising campaign.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a perspective view of a newspaper with the wipe affixed, in accordance with one embodiment of the present invention;

FIG. 2 illustrates a drawing a drawing of a snack food bag with the wipe affixed, in accordance with one embodiment of the present invention;

FIG. 3 illustrates a drawing of a perspective view of a pizza box with the wipe affixed, in accordance with one embodiment of the present invention; and

FIG. 4 illustrates a drawing of a wipe with an adhesive, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

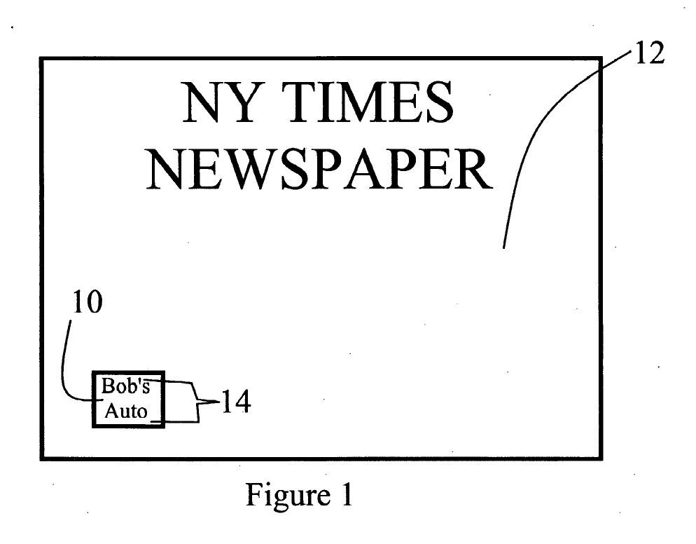

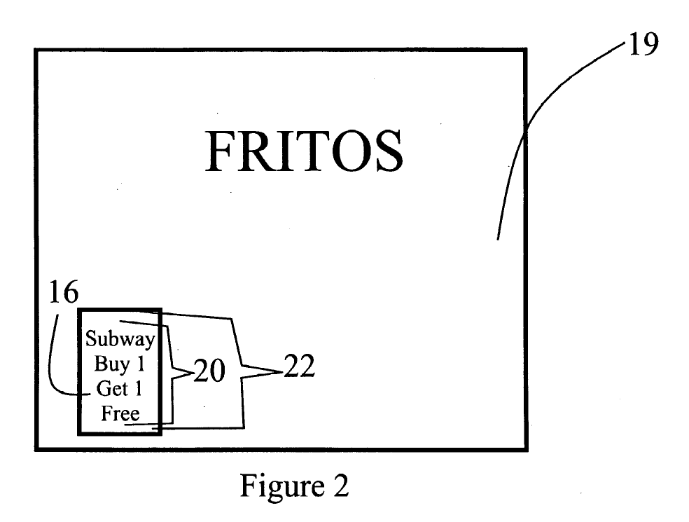

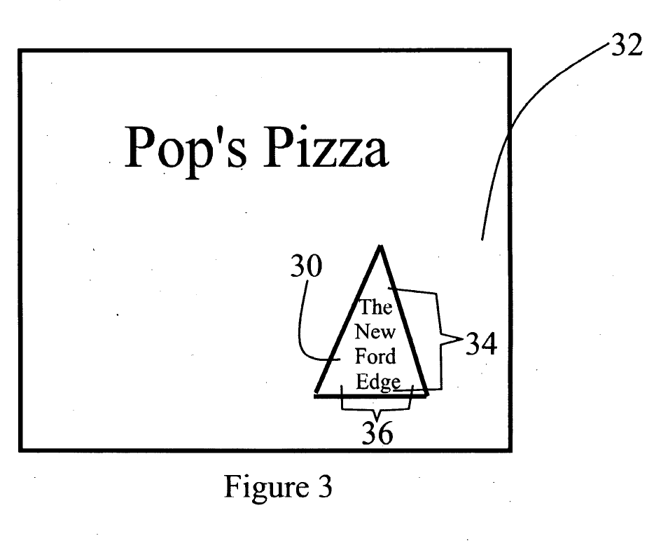

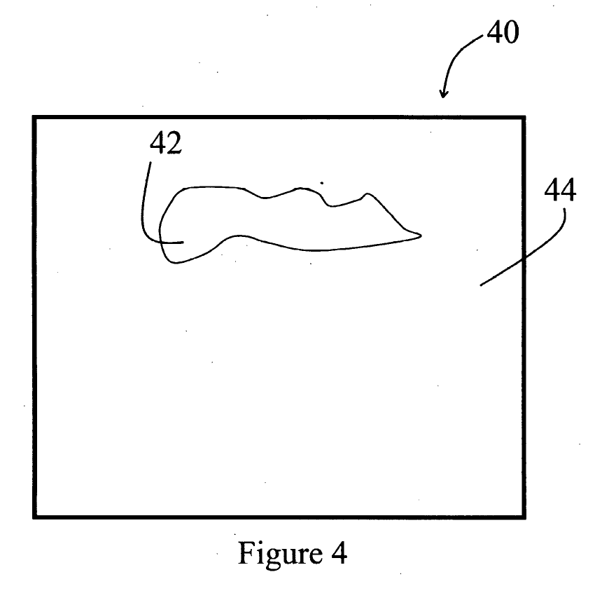

Referring now to FIG. 1 as in one embodiment shown is a wipe 10. The wipe 10 is affixed to a newspaper 12, newspaper 12 will often soil hands of a user with ink so the newspaper 12 with the wipe 10 becomes a more desirable product to a user. The wipe 10 shows an advertising space 14 with an advertisement for Bob's Auto within. Referring to FIG. 2 as in one embodiment shown is a wipe 16 with a national advertising campaign with a coupon for Subway Restaurant 20 in a coupon advertising space 22. Wipe 16 is affixed to a snack food bag 19, the snack in the snack food bag 19 may soil hands of a user. Referring to FIG. 3 as in one embodiment shown is a wipe 30 affixed to a pizza box 32. Promotional advertising space 34 has inside a promotional advertisement for The New Ford Edge 36. Referring to FIG. 4 as in one embodiment shown is a wipe 40 with an adhesive 42 on a back surface 44 of the wipe 40.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A device comprising:
a package with a third party advertising space;
a media inside the package; and
a product with the package disposed about the product.

2. The device of claim 1 wherein the package has the adverting on an outside surface.

3. The device of claim 1 wherein the media has the advertising space.

4. The device of claim 1 wherein the media is a wipe and the package is attached to the product by a selected one of gluing the package to the product and stapling the package to the product.

5. The device of claim 1 wherein the third party advertising space is a national advertising campaign.

6. The device of claim 1 wherein the third party advertising space is a local advertising campaign, the advertising space is in a shape associated with the product.

7. The device of claim 1 wherein the third party advertising space is a coupon.

8. A method comprising:
attaching a wipe to a product; and
advertising on the wipe.

9. The method of claim 8 wherein the product is one that would need a wipe by a user of the product.

10. The method of claim 8 wherein the wipe has packaging surrounding the wipe the packaging contains the advertising.

11. The method of claim 8 wherein the wipe contains the advertising.

12. A device comprising:
a package with a third advertising space on the package;
a cleaning wipe inside the package; and
a product with the package placed on the product, the product is one that would have a user need a wipe to clean body parts of the user after using the product.

13. The device of claim 12 wherein the package has the adverting on an outside surface.

14. The device of claim 12 wherein the advertising is on the wipe.

15. The device of claim 12 wherein the package is attached to the product by a selected one of gluing the package to the product and stapling the package to the product.

16. The device of claim 12 wherein the package is placed inside the product.

17. The device of claim 12 wherein the package is placed on an outside surface of the product.

18. The device of claim 12 wherein the product is one which would prompt a user to use the cleaning wipe.

19. The device of claim 12 wherein the third party advertising space is a selected one of a coupon, national campaign and local campaign.
